(19) United States
(12) Patent Application Publication
(10) Pub. No.: US 2006/0260314 A1
(43) Pub. Date: Nov. 23, 2006

(54) Method and system integrating combined cycle power plant with a solar rankine power plant

(76) Inventors: Ronald Farris Kincaid, Los Alamitos, CA (US); Mark Joseph Skowronski, San Clemente, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/390,294

(22) Filed: Mar. 27, 2006

Related U.S. Application Data
(60) Provisional application No. 60/665,048, filed on Mar. 25, 2005.
(60) Provisional application No. 60/693,111, filed on Jun. 23, 2005.

(51) Int. Cl. F03G 6/00; F01K 13/00; B60K 16/00; B60L 8/00

(52) U.S. Cl. 60/641.8; 60/645

(57) ABSTRACT

A combined cycle power generation system can be combined with a solar Rankine power generation system such that the integrated system has improved power generation efficiency over two stand-alone systems. Relatively high temperature, low pressure reheat from the combined cycle power generation system can be used, through, for example, a superheater, to raise the temperature and pressure of a working fluid in a solar Rankine power generation system. The resulting integrated system has enhanced efficiencies as compared with stand-alone systems.

### CROSS-REFERENCE TO RELATED APPLICATIONS

This application claims the benefit of U.S. Provisional Patent Application No. 60/665,048, entitled “Method to Integrate Fossil Fueled Combined Cycle Power Plant with a Solar Rankine Power Plant,” filed on Mar. 25, 2005; and U.S. Provisional Patent Application No. 60/693,111, entitled “Method to Integrate Fossil Fueled Combined Cycle Power Plant with a Solar Rankine Power Plant Using a Common Steam Turbine,” filed on Jun. 23, 2005. These provisional applications are incorporated by reference herein in their entireties.

### BACKGROUND OF THE INVENTION

1. Field of the Invention

The application relates generally to systems and methods for power generation and more specifically to systems and methods for integrating a fossil fueled combined cycle power generation system with a solar Rankine power generation system with enhanced power generation efficiency.

2. Description of the Related Art

Solar thermal generation can be used to generate clean, on-peak energy when used in conjunction with a fossil fuel for backup. Solar thermal generation can be easily hybridized and provide the premium energy desired by summer peaking utilities. Solar-powered generation generally follows the energy load of summer peaking utilities, thereby providing the on-peak energy when it is needed most, i.e., during higher temperature daylight hours. Although simple and reliable, such solar thermal generation facilities are inefficient and cannot compete, in most cases, with traditional fossil fuel generated electrical energy.

Attempts have been made to increase the efficiency of solar thermal generating facilities by combining such facilities with combustion turbine electric generator systems. One example is a system called an Integrated Solar Combined Cycle System (ISCCS), developed by Sandia National Laboratories. The ISCCS is illustrated in FIG. 1.

In an ISCCS, the traditional steam Rankine cycle of the solar thermal generation unit is combined with the Brayton cycle of a combustion turbine generating facility. In these systems, working fluid vapor is produced in a working fluid vaporizer using heat developed in a solar thermal array. The working fluid vapor is then transferred to a heat recovery device such as a heat recovery steam generator.

The heat recovery steam generator not only provides super heat for the working fluid vapor produced in the vaporizer, but can also produce additional working fluid vapor in one or more additional vaporizers. Heat for preheating recycled working fluid condensate is also provided by the heat recovery steam generator.

The heat recovery steam generator produces both a high pressure stream of working fluid vapor, a low pressure stream of working fluid vapor and, depending on the system configuration, an intermediate pressure stream of working fluid vapor (combined in FIG. 1 with the cold and hot reheat pressures). These working fluid vapor streams are utilized in a working fluid vapor turbine electric generator to produce electricity. As illustrated in FIG. 1, exhaust streams from the high pressure and low pressure working fluid vapor streams are returned from the working fluid vapor turbine electric generator to the heat recovery system generator in separate lines.

The ISCCS system, unfortunately, has several shortcomings. The solar fractional portion of the total electric energy generated is very low. Thus, many ISCCS plants cannot qualify for various tax and other economic incentives provided by local governing bodies for renewable energy producing facilities. Also, the heat recovery steam generator is inherently inefficient, since it must be carefully designed as a combined unit and cannot be efficiently operated when there is no solar heat addition. Finally, the ISCCS is highly complex in design and operation, and is, for that reason, expensive to build, maintain and operate.

### SUMMARY OF THE INVENTIONS

An aspect of at least one of the embodiments disclosed herein includes the realization that solar thermal generators can be made more efficient by utilizing heat from a combined cycle generation system. For example, currently available solar boilers are only able to generate steam of about 700° F. at about 700 psi. This is due to the limitations of the oils used in solar thermal arrays for transporting thermal energy from the solar array to the boiler. However, hardware normally used in power generation plants, including plumbing and expansion turbines, are often designed to operate with steam at pressures well over 1000 psi and temperatures well over 1000° F. Thus, in some embodiments, higher temperature but lower pressure steam from a Heat Recovery System Generator, such as those commonly used in combined cycle systems, can be used to further super heat the steam in a solar thermal system before it is delivered to the expansion turbine. As such, the energy transferred from the lower pressure steam has more thermodynamic “availability” after it is transferred to the much higher pressure but lower temperature solar-generated steam. This is because, as is well understood by those of ordinary skill in the art, pressure is the only form of energy that can be used to drive an expansion generator.

For example, very high temperature steam (1200° F.) at atmospheric pressure cannot be used to drive an expansion turbine. Thus, even though the steam at 1200° F. and atmospheric pressure contains a large amount of thermal energy, this energy is not “available” for use in an expansion turbine; expansion turbines cannot convert thermal energy into shaft power. Rather, expansion turbines rely on the flow of a fluid, such as steam, from a high pressure source, across the turbine, to the low pressure exhaust side of the turbine to generate shaft power.

Thus, in accordance with at least one embodiment, a method for generating power can be provided. The method can comprise generating a heated reheat of a first working fluid in a first power generation system and vaporizing a second working fluid liquid in a second power generation system to form a second working fluid vapor. The method can also comprise transferring energy from the reheat of the first working fluid to the second working fluid vapor thus increasing a temperature and a pressure of the second working fluid vapor of the second power generation system.

In accordance with at least one embodiment, a method to increase the thermodynamic availability of a first working fluid vapor having a first temperature and a first pressure can be provided. The method can comprising the steps of transferring the first working fluid vapor to a superheater and transferring a second working fluid vapor to the superheater, the second working fluid vapor having a second temperature that is lower than the first temperature and a second pressure that is higher than the first pressure. The method can also comprise transferring heat energy in the superheater from the first working fluid vapor to the second working fluid vapor to increase the temperature and pressure of the second working fluid vapor.

In accordance with at least one embodiment, a power generation system can comprise a solar energy collector, and a solar boiler connected to the solar collector with a working fluid conduit configured to circulate a first working fluid to transfer heat from the solar energy collector to the solar boiler. The power generation system can also include a first expansion turbine and a steam circuit extending from the solar boiler to the first expansion turbine. Additionally, a heat transfer device connected to the steam circuit between the solar boiler and the first expansion turbine, the heat transfer device being configured to transfer heat from reheated steam in a combined cycle power generation system to steam in the solar steam circuit.

### BRIEF DESCRIPTION OF THE DRAWINGS

FIG. 1 is a schematic diagram of an Integrated Solar Combined Cycle System of the prior art;

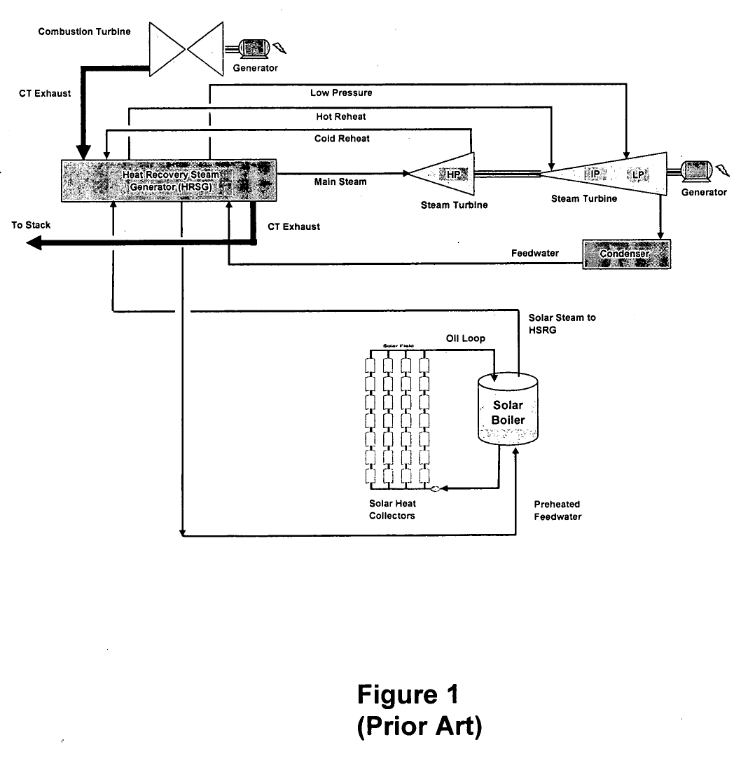

FIG. 2 is a schematic diagram of separate combined cycle and solar Rankine power generation systems of the prior art;

The above-mentioned and the other features of the inventions disclosed herein are described below with reference to the drawings of the preferred embodiments. The illustrated embodiments are intended to illustrate, but not to limit the inventions. The drawings contain the following figures:

FIG. 3 is a schematic diagram of an embodiment of an integrated power generation system;

FIG. 4 is a schematic diagram of another embodiment of an integrated power generation system;

FIG. 5 is a schematic diagram of a further embodiment of an integrated power generation system;

FIG. 6 is a schematic diagram of yet another embodiment of an integrated power generation system.

### DETAILED DESCRIPTION OF THE PREFERRED EMBODIMENTS

The following discussion describes in detail several embodiments of power generation systems and various aspects of these embodiments. This discussion should not be construed, however, as limiting the present inventions to those particular embodiments. Practitioners skilled in the art will recognize numerous other embodiments including those that can be made through various combinations of the aspects of the illustrated embodiments.

Combined Cycle Power Generation System

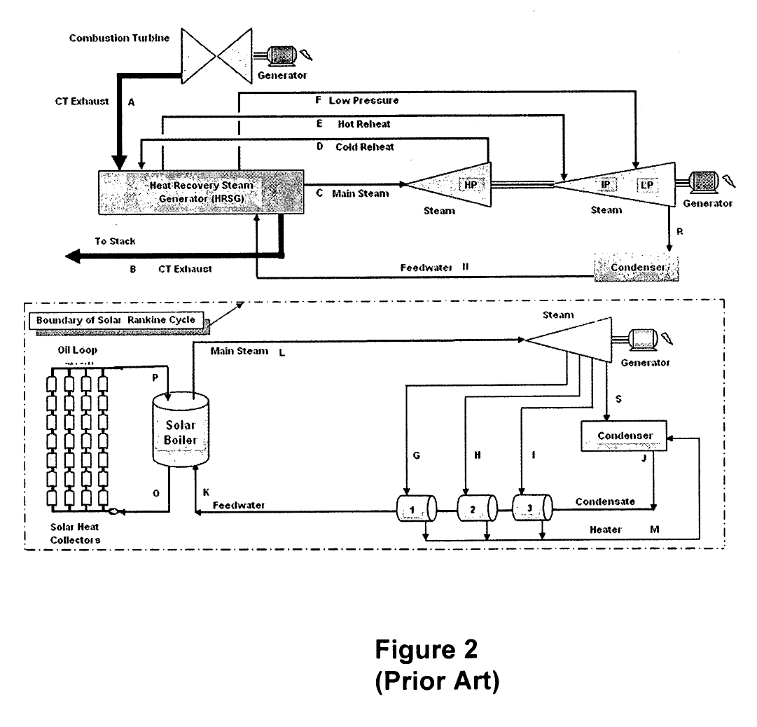

A three pressure combined cycle with reheat is used in the embodiments of combined cycle power generation systems discussed herein, although other combined cycles and other configurations of multiple pressure combined cycles can also be used. An illustrative three pressure combined cycle is illustrated in the upper portion of FIG. 2.

In the illustrated combined cycle power generation system, a Brayton cycle combustion turbine is used as a topping cycle with the exhaust (A) of the combustion turbine (CT) used to supply heat to a bottoming Rankine cycle. As illustrated, water is the working fluid for the bottoming Rankine cycle, although in other embodiments, other working fluids could be used.

The combustion turbine uses hot exhaust gas from the combustion of a fuel to drive a turbine and a generator. Operation of the combustion turbine thus generates electricity and produces a flow of hot exhaust gas. Steam flows and pressures used in the bottoming Rankine cycle are the result of heat extraction from the exhaust flow of the CT. After the usable heat is extracted from the CT exhaust, the exhaust flow (B) is directed to a heat rejection stack.

As illustrated in the combined cycle of FIG. 2, “main steam” is produced in a heat recovery device such as a Heat Recovery Steam Generator (HRSG) and exits the HSRG over flow path (C). The “main steam” can be considered to be the highest temperature and pressure stem output by the HRSG. The main steam can be expanded in a high pressure steam turbine (HP). In the illustrated embodiment, the turbine is a triple pressure turbine with a high pressure turbine connected by a shaft to another multi pressure turbine having an intermediate pressure portion (IP) and a low pressure portion (LP). However, other turbine arrangements can also be used.

After partial expansion in the high pressure steam turbine (HP), the steam is routed via flow path (D) and returned to the HRSG as “cold reheat” for further heating by the combustion turbine exhaust flow (A). This “cold reheat” steam is heated by the HRSG and then exits the HSRG as “hot reheat” through the flow path (E).

The “hot reheat” steam flow is then expanded in an intermediate pressure portion IP of the turbine and can continue to expand through the low pressure portion (LP) of the turbine. In some embodiments, a low pressure steam flow (F) from the HSRG can be added to the flow of hot reheat as it enters the low pressure portion (LP). After expansion in the (IP) and (LP) portions of the turbine, these stem flows are condensed in the condenser.

Typically, the main steam entering the high pressure turbine over flow path (C) is at a pressure of approximately 1,800 psia; the hot reheat in flow path (E) enters the intermediate pressure turbine having a pressure in the range of 350-500 psia; and, the low pressure steam in flow path (F) enters the low pressure turbine having a pressure in the range of ˜50 psia. All steam produced at all three pressures can be expanded in a triple pressure turbine (HP), (IP), (LP) and flows to a condenser over flow path (R). Power is extracted, for example by electrical generators, from both the combustion turbine and the triple pressure turbine (HP), (IP), (LP).

Solar Rankine Power Generation System

A solar Rankine power generation system is illustrated in the lower portion of FIG. 2, within the dashed border labeled “Boundary of Solar Rankine Cycle” and comprises a steam Rankine cycle. The solar thermal generation system can have gas assist (e.g., a fuel-fired burner) to provide energy during cloudy or rainy days and for emergency generation.

In the system illustrated in FIG. 2, thermal energy is collected by a solar energy array, such as the illustrated Solar Heat Collectors. Within the collectors, the colleted heat is transferred to a heat absorbing transfer fluid. The heat absorbing transfer fluid can be selected to have desirable thermodynamic properties. Desirably, the heat absorbing transfer fluid is an oil. Typical solar energy transfer fluids for use in a solar Rankine power generation system can be mineral oil for temperatures up to 600° F. and diphenyl oxide/biphenyl-based products for temperatures exceeding 600° F.

The heated oil, or other transfer fluid, circulates in thermal contact with a working fluid liquid in a vaporizer. In the illustrated embodiment, the working fluid liquid is water, although other liquids could be used in other embodiments.

As illustrated in FIG. 2, the vaporizer can be a Solar Boiler through which the heated oil (following the Oil Loop from flow paths (P) to (O)) and the working fluid (following a working fluid flow path from (K) to (L)) flow. In the vaporizer, the working fluid liquid is vaporized to a working fluid vapor. In the illustrated embodiments, the working fluid is water and the working fluid vapor is steam.

The working fluid vapor produced in the vaporizer can then be further heated in one or more superheaters (not illustrated). In a typical solar thermal generation facility, the heat required by the one or more superheaters is provided by a fossil fuel burning heater. The working fluid vapor can then be used to generate electricity by driving a working fluid vapor turbine electric generator, such as the illustrated steam turbine electric generator. This power generation is illustrated as main steam following a steam flow path (L) to a steam turbine in FIG. 2. As illustrated, upon exit over flow path (S) from the working fluid vapor turbine electric generator, the working fluid vapor is condensed, deaerated, heated in one or more feedwater heaters (1), (2), (3) and recycled back to the Solar Boiler.

The solar Rankine cycle is typically a regenerative cycle and, in various embodiments, can be used with and without reheats and with and without feedwater heaters (1), (2), (3). In the illustrated solar Rankine cycle, no reheats are present. Additionally, three extraction flow paths (G), (H), (I) transfer partially expanded steam from the steam turbine to three corresponding feedwater preheaters (1), (2), (3). In other embodiments, a solar Rankine power generation system can include more or fewer than three extraction flow paths and feedwater heaters, and the numbers and properties of which can be chosen based on desired performance or economic considerations. The feedwater heater drains are routed back to the condenser over flow path (M) such that the partially expanded steam used to preheat the working fluid feedwater is condensed and recirculated. Alternatively, they can be cascaded through the heaters. The use of reheats and preheaters can increase the efficiency of a solar Rankine cycle. But, often, this increased efficiency is at the expense of increased costs and complexity. Therefore, the number and configuration of reheats and preheaters can be determined by economic considerations.

One difference between a fossil fuel fired Rankine cycle and the solar Rankine cycle illustrated in FIG. 2 is the replacement of a fossil fuel boiler with the Solar Boiler. Typically, the main steam flow over flow path (L) produced by the Solar Boiler is limited to approximately 700° F. due to the temperature limitations of the hot oil flow (P) used to collect heat in the solar heat collectors. Likewise, due to limitations of the hot oil flow (P), the main steam flow over flow path (L) is typically limited to a pressure of approximately 700 psia.

Integrating the Combined Cycle with the Solar Rankine Cycle

As discussed above, one approach to increasing the efficiency of a solar Rankine power generation system has been to integrate it with a combined cycle power generation system in an ISCCS. However, the ISCCS system only marginally improves power plant performance and requires substantial redesign of the Heat Recovery Steam Generator (HRSG) of the combined cycle. Several embodiments of integrated power generation system are discussed herein that improve upon the ISSCS system by enhancing overall efficiency, reducing costs, and reducing both complexity and risk since no modification to the HRSG is required. While the illustrated embodiments relate to integrating a three pressure combined cycle power generation system with a solar Rankine power generation system, it is contemplated that in other embodiments, other combined cycles can be used with the systems and methods disclosed herein to increase performance of two integrated power generation systems.

Methods are provided herein for increasing the efficiency of an integrated power generation system. These methods are further disclosed herein in the context of various embodiments of integrated power generation systems. The methods disclosed herein include transferring, for example through use of a superheater, heat energy from reheat of a first working fluid of a first power generation system to a second power generation system. in some of the embodiments described herein, the hot reheat of the first working fluid has a relatively high temperature, but low pressure and the second working fluid has a moderate temperature and moderate pressure. Both the temperature and the pressure of the second working fluid are increased by the heat energy transfer (which can require higher pressure feedwater pumping). The resulting increased temperature and pressure results in greater availability and a lower enthalpy at the second working fluid steam turbine expansion line end point than would be achieved by stand-alone systems.

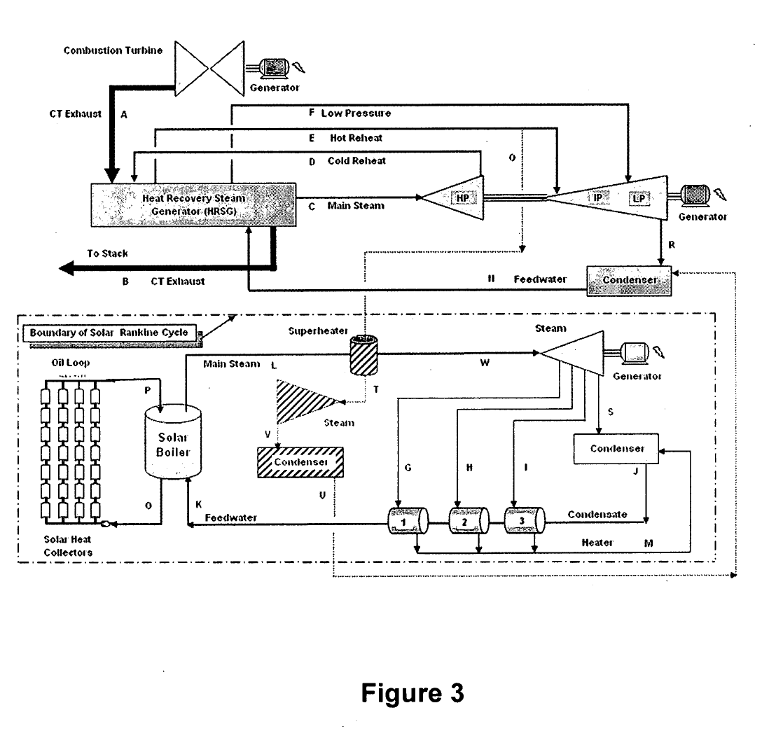

FIG. 3 is a schematic flow diagram illustrating an embodiment of an integrated power generation system that overcomes shortcomings associated with the ISCCS. As illustrated, the high temperature, but low pressure, hot reheat, in flow path (E), of the working fluid of the combined cycle is routed over flow path (Q) to provide further superheating of steam in the Solar Rankine cycle. In the illustrated embodiment, the heat transfer device is a superheater, although in other embodiments, other heat transfer devices can be used.

The transfer of energy from the hot reheat to the working fluid of the solar Rankine cycle creates higher thermodynamic availability by effectively allowing the solar Rankine cycle working fluid to be expanded at a higher pressure. Thus, the total enthalpy output of the combined cycle working fluid is increased, resulting in higher generator output when compared to the same amount of heat input into the combined cycle and solar Rankine cycle. The increased enthalpy in the solar Rankine power generation system results in a longer turbine expansion line and lower exhaust end point on a Mollier diagram.

In various embodiments, additional efficiency enhancements can be gained from the use of regeneration and the pre-heating of the return oil to the solar collectors in the solar Rankine cycle. Although the illustrated embodiments include a three pressure combined cycle system, the enhanced efficiency of this integrated power generation system can also be attained in single and double pressure configurations depending on the operating parameters of the combined cycle.

Referring to FIG. 3, the integration of the two power generation systems is shown cross-hatching and dotted lines. As noted above, in the illustrated embodiments, a portion the hot reheat of the working fluid in flow path (E) in the combined cycle power generation system follows flow path (Q) and is transferred to the Superheater. In some embodiments, some portion of the hot reheat is transferred over flow path (Q), while in other embodiments, substantially all of the hot reheat is transferred over flow path (Q). Alternatively, the portion of hot reheat transferred from flow path (E) to flow path (Q) can be varied as power generation conditions dictate.

For example, in some embodiments, integrated power generation systems can include a valve to allow a power generation operator to arrest flow of hot reheat over flow path (Q) during night hours or periods of substantial cloudiness when the Solar Boiler would not adequately generate working fluid vapor in the solar Rankine cycle.

As illustrated, the working fluid vapor of the solar Rankine cycle is vaporized in the Solar Boiler, then is transferred, over flow path (L) to the Superheater. It is contemplated that the Superheater can be one of various designs of heat exchanging device known in the art with desired heat transfer capabilities and properties. In the Superheater, heat energy is transferred from the hot reheat working fluid vapor of the combined cycle, which is at a relatively high temperature, but a relatively low pressure, to the working fluid vapor of the solar Rankine cycle, which is at a temperature and pressure limited by operating constraints of the Solar Boiler.

For illustrative purposes, common flows and temperatures for a three pressure combined cycle power generation system and a regenerative solar Rankine power generation system are discussed below. However, different power generation system configurations can use different working temperatures and pressures. In the embodiments illustrated in FIG. 3, where water is used as the working fluid for both the combined cycle power generation system and the solar Rankine power generation system, the hot reheat steam in flow path (E) of the combined cycle power generation system is at a pressure approximately in the range of 350-500 psia and a temperature of approximately 1,050° F.

The steam generated by the Solar Boiler, is at a pressure of approximately 700 psia and a temperature of approximately 700° F. In the Superheater, the energy transfer from the hot reheat steam diverted over flow path (Q) raises the temperature of the steam in the solar Rankine cycle to approximately 1,000° F. (reflecting an approximately 50° F. “pinchpoint”). This increase in temperature of the steam in the solar Rankine cycle is accompanied by a corresponding increase in pressure to approximately 1,200 psia. This higher pressure steam then follows flow path (W) and is expanded in a steam turbine that drives a power generator in the solar Rankine cycle.

The higher pressure steam in the turbine will have a lower turbine enthalpy point at the end of the expansion line than would be present for a turbine driven by the hot reheat of the combined cycle power generation system. Thus, by exchanging the heat to a higher pressure fluid in the solar Rankine cycle power generation system, greater availability is established and a lower enthalpy is achieved at the steam turbine expansion line end point than could be achieved for the two illustrated power generation systems operating independently as in FIG. 2).

As illustrated in FIG. 3, the hot reheat steam diverted over flow path (Q) from the combined cycle power generation system is cooled in the Superheater from 1050° F. to a lower temperature steam. In the illustrated embodiments, this lower temperature steam follows flow path (T) exiting the Superheater towards an expansion turbine. This cooling results in a lower turbine expansion line endpoint and thus a lower exhaust enthalpy as compared to the combined cycle power generation system steam turbine expansion line for the intermediate pressure steam. Lowering the end point of the expansion line increases the thermodynamic availability and improves the overall efficiency of the integrated heat cycle when compared to the two standalone systems. This increase in overall integrated cycle efficiency can be realized in a smaller solar field. Thus, there can be reduced solar heat input into the integrated cycles, however, the overall output of the integrated cycles will remain the same when compared to two standalone cycles.

As illustrated in FIG. 3, the working fluid of the combined cycle follows flow paths (T), (V), (U) out of the Superheater, through a turbine, and through a condenser. This flow through a turbine and condenser allows the working fluid of the combined cycle to be more easily pumped as a condensate. However, it is contemplated that in other embodiments, the working fluid of the combined cycle could be recirculated directly to the condenser of the combined cycle power generation system.

As illustrated, the working fluid condensate is returned to the combined cycle over flow path (U) where it can be recirculated in the combined cycle power generation system over flow path (N). Thus, in the illustrated embodiments, the combined cycle working fluid and the solar Rankine cycle working fluid are not mixed. Rather, only heat is exchanged between the two working fluids. Therefore, while the illustrated embodiment and discussion thereof relates to the use of water as the working fluid in both cycles, in other embodiments, each cycle can use a different working fluid.

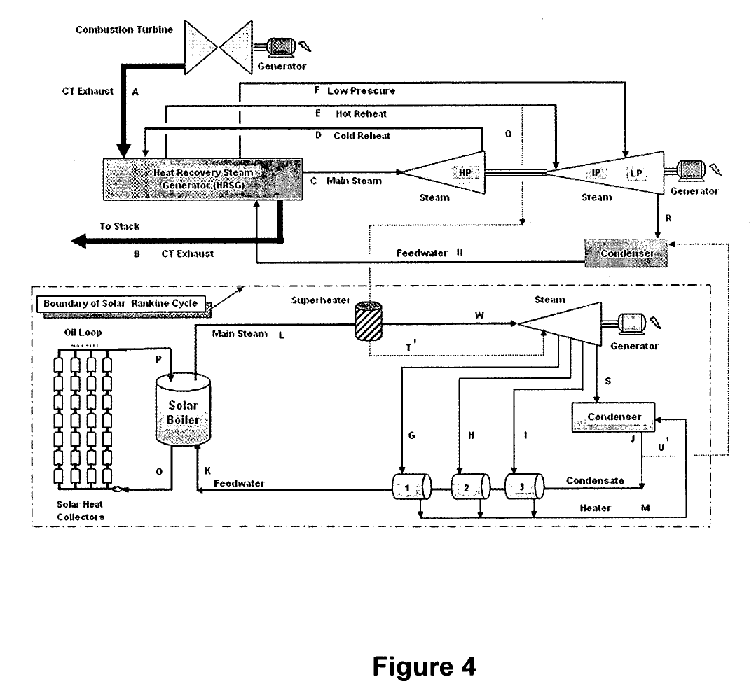

With reference to FIG. 4, other embodiments of integrated power generation systems are disclosed. As with the embodiments of FIG. 3, dotted lines and hashed marks indicate the integration of a combined cycle power generation system with a solar Rankine power generation system. As with the embodiments of FIG. 3, hot reheat of the working fluid of the combined cycle power generation system flows to a heat exchange device such as a Superheater where it heats working fluid vapor of the solar Rankine cycle. In the embodiments illustrated in FIG. 4, where the working fluids of each power generation system are water, the temperatures and pressures of the working fluids entering and exiting the Superheater are approximately within the ranges discussed above with respect to the embodiments of FIG. 3. Likewise, approximately the same increase in “equivalent” availability discussed above with respect to the embodiments of FIG. 3 occurs with the heat transfer in the Superheater in the embodiments of FIG. 4.

In the embodiments illustrated in FIG. 4, however, the working fluids of the combined cycle power generation system and the solar Rankine power generation system are commingled. The working fluid of the combined cycle power generation system follows flow path (T′) from the Superheater and drives the turbine of the solar Rankine power generation system. Thus, in the solar Rankine power generation system turbine, the working fluids of the two power generation systems are commingled. In the embodiments illustrated in FIG. 4, the resulting mixed working fluid is then routed out of the turbine either to feedwater heaters (1), (2), (3) or over flow path (S) to a condenser.

A portion of the mixed working fluid condensate exiting the condenser over flow path (J) is recirculated over flow path (U′) to the combined cycle power generation system. To avoid accumulation of working fluid in one of the power generation systems, the volume of condensate that is recirculated over flow path (U′) can be metered to maintain sufficient volumes of working fluid in each power generation system.

Advantageously, the embodiments illustrated in FIG. 4 enhance the efficiency of an integrated power generation system without requiring an additional expansion turbine and condenser for the combined cycle working fluid. Thus, the embodiments illustrated in FIG. 4 can more economically provide enhanced efficiency. However, since the working fluids of each power generation system are mixed, different working fluids can not be used in each of the power generation systems.

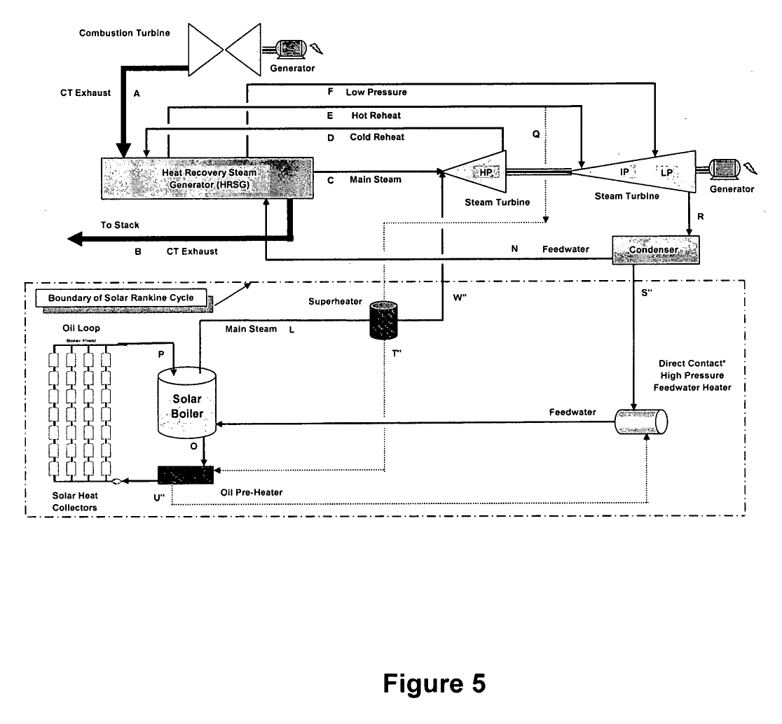

With reference to FIG. 5, further embodiments of integrated power generation systems are disclosed. As with the previously-discussed embodiments, in the embodiments of FIG. 5, hot reheat in flow path (E) of the working fluid of the combined cycle power generation system is diverted over flow path (Q) to a heat exchange device such as a Superheater where it transfers heat energy to a working fluid vapor of the solar Rankine power generation system. Where the working fluids are water, the temperatures and pressures of the working fluids before and after passing through the Superheater are approximately the same in the embodiments illustrated in FIG. 5 as those discussed above with reference to FIG. 3, although the pressure of the solar Rankine cycle working fluid exiting the Superheater can be raised, for example to approximately 1,800 psia, to be compatible with the pressure of main steam of the combined cycle power generation system in flow path (C) entering the turbine of the combined cycle power generation system as discussed further below.

Unlike the previously-discussed embodiments, in some embodiments of FIG. 5 both the combined cycle power generation system and the solar Rankine power generation system can drive a common turbine. This use of a common turbine can combine the efficiency advantages discussed above with lower equipment costs and reduced system complexity.

In the embodiments of FIG. 5, the integration of the solar Rankine power generation system with a combined cycle power generation system can be made without significant modifications to either the heat recovery device or the turbine of the combined cycle power generation system. The additional output from the combined cycle power generation system turbine resulting from the addition of the solar cycle can be provided without modification to the turbine due to additional steaming capacity normally designed into the combined cycle for power generation by duct firing.

Typically, combined cycle power generation systems are outfitted with duct firing in order to boost the output by 10% or higher. When duct fired, the incremental heat rate is significantly higher than the plant heat rate and, consequently, duct firing is normally performed only when additional peaking capacity/energy is required. Thus, a turbine of a combined cycle power generation system typically has additional power generation capacity that remains unused during normal operating conditions. As illustrated in FIG. 5, this additional power generation capacity can be efficiently used through integration with a solar Rankine cycle power generation system. Thus, the integration can be made without modification to the turbine.

In the illustrated embodiments, the superheated working fluid vapor generated by the solar Rankine cycle is exits the Superheater over flow path (W″) and is fed into the turbine of the combined cycle power generation system. This working fluid vapor flow from the solar Rankine cycle power generation system utilizes spare turbine capacity that would otherwise be available for use with duct firing. Duct firing can still be performed to provide back up for the solar Rankine cycle power generation system during cloud transients, rainy days or whenever emergency capacity/energy is needed as the duct firing is always available notwithstanding the operation of the solar system.

In the embodiments of integrated power generation system illustrated in FIG. 5, hot reheat steam in flow path (E) of the combined cycle power generation system, in whole or in part, is directed to the Superheater over flow path (Q). In the Superheater there is an availability increase by transferring higher temperature steam entering from flow path (Q) at a lower pressure to create a slightly lower temperature but higher pressure solar Rankine cycle steam exiting the Superheater over flow path (W″). The higher temperature solar steam is then directed to the combined cycle power generation system's main steam header where it mixes with the main steam in flow path (C) from the HRSG for introduction into the steam turbine of the combined cycle power generation system.

In the embodiments illustrated in FIG. 5, the working fluid of the combined cycle power generation system, now at a reduced temperature from being cooled in the Superheater is directed to an Oil Pre-Heater over flow path (T″). In alternative embodiments, no oil pre-heater is present. As illustrated, the combined cycle power generation system working fluid pre-heats oil circulating in the Oil Loop as the oil is being routed from the Solar Boiler to the Solar Heat Collectors. The oil is then heated once again in the solar field; the oil, in flow path (P), is then directed back to the Solar Boiler. Since there is still significant heat in the combined cycle power generation system working fluid, this working fluid is routed from the Oil Pre-Heater over flow path (U″) to a Direct Contact High Pressure Feedwater Heater, where it is used to pre-heat the solar Rankine cycle power generation system working fluid.

Alternatively, a more traditional shell and tube heater where the drips are returned to the condenser can be used to preheat the solar Rankine cycle working fluid. Since the working fluids of the two cycles are commingled in the turbine, the solar Rankine cycle working fluid can be supplied by a side stream on flow path (S″) from the combined cycle power generation system condenser. Thus, in the embodiments of FIG. 5 only a single condenser and high pressure turbine is present in the integrated power generation system.

While the integrated power generation system embodiments of FIG. 5 provide enhanced efficiency and economy over stand alone power generation systems, it is contemplated that these common turbine embodiments might not be desirable in all instances. It is noted that not all existing combined cycle power generations systems have the extra capacity margins for duct firing, and modification to or substitution of the turbine can be made to integrate those systems with a solar Rankine power generation system. Moreover, it is contemplated that the individual power generation systems comprising the integrated power generation systems disclosed herein can each be owned and/or operated by different entities.

Where different entities own the individual power generation systems, concerns may arise over the purity of the working fluid flow entering the combined cycle turbine. For example, in embodiments where water steam is the working fluid vapor, in a steam turbine, if the steam flow includes droplets or impurities, there can be a risk of damage to the turbine. Therefore while the common turbine of embodiments of FIG. 5 may present certain economic advantages, a power generation system operator owning a combined cycle power generation system may not desire to let others connect working fluid vapor lines to the turbine.

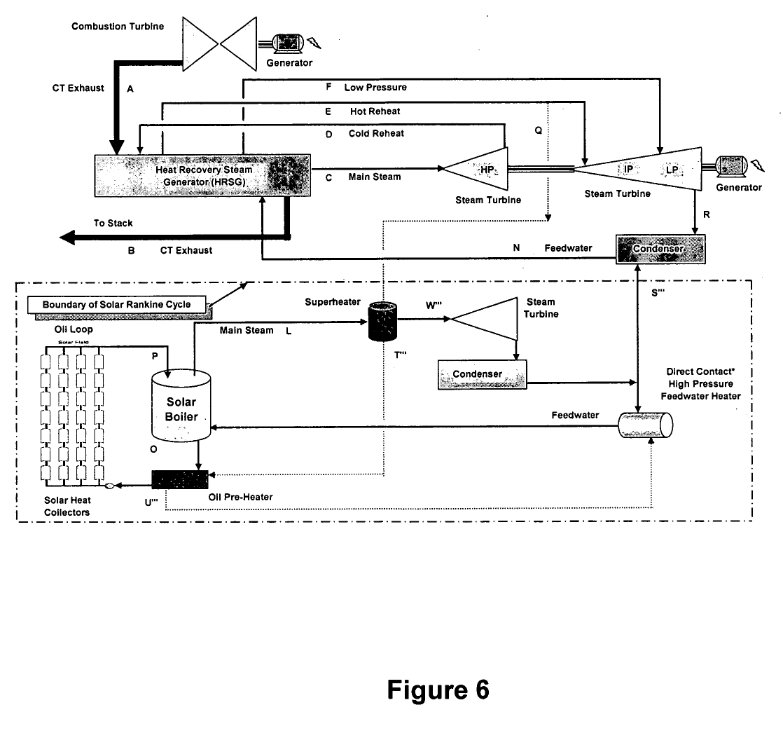

With reference to FIG. 6, still other embodiments of integrated power generation systems are disclosed. As with the previously-discussed embodiments, in the embodiments of FIG. 6, hot reheat in flow path (E) of the working fluid of the combined cycle power generation system flows over flow path (Q) to a heat exchange device such as a Superheater where it transfers heat energy to a working fluid vapor of the solar Rankine power generation system. Where the working fluids are water, the temperatures and pressures of the working fluids before and after passing through the Superheater are approximately the same in the embodiments illustrated in FIG. 6 as those discussed above. As the solar Rankine cycle working fluid exits the Superheater, it is expanded in a turbine to drive a generator. From the turbine, the solar Rankine cycle working fluid can be condensed in a condenser and recirculated as working fluid condensate.

In the embodiments of FIG. 6, the working fluid of the combined cycle power generation system, now at a reduced temperature from being cooled in the Superheater is directed to the Oil Pre-Heater over flow path (T′″). In alternative embodiments, no oil pre-heater need be present. As illustrated, the combined cycle power generation system working fluid pre-heats oil circulating in the Oil Loop as the oil is being routed from the Solar Boiler to the Solar Heat Collectors. The oil is then heated once again in the solar field; the oil in flow path (P) is then directed back to the Solar Boiler. Since there can still be significant heat in the combined cycle power generation system working fluid, this working fluid is routed from the Oil Pre-Heater over flow path (U′″ ) to a Direct Contact High Pressure Feedwater Heater, where it is used to pre-heat the solar Rankine cycle power generation system working fluid.

Alternatively, a more traditional shell and tube heater where the drips are returned to the condenser can be used to preheat the solar Rankine cycle working fluid. Since as illustrated the working fluids of the two cycles are commingled in the feedwater heater, the solar Rankine cycle working fluid can be supplied by a side stream on flow path (S′″) from the combined cycle power generation system condenser.

In the embodiments illustrated in FIG. 6, the working fluids of the combined cycle power generation system and the solar Rankine cycle power generation system are commingled between the combined cycle power generation system condenser and the solar Rankine cycle Feedwater Heater. In some embodiments, a flow control device such as a metering valve can be used to prevent the commingled working fluid from accumulating in one of the power generation systems or another. It is contemplated that other embodiments of integrated power generation system can include certain aspects of the embodiments of FIG. 6 such as an Oil Pre-Heater and a Direct Contact High Pressure Feedwater Heater.

In any of the embodiments discussed above with reference to FIGS. 3, 4, 5, and 6, integrated power generation systems provide the power generation system operator with many advantages over systems of the prior art. The integrated power generation systems provide increased overall efficiency. With the superheat of the working fluid vapor of the solar Rankine cycle power generation system, the integrated power generation system produces a more efficient integrated cycle when compared to a standalone solar Rankine cycle and a standalone combined cycle. This efficiency increase can be measured by the overall reduced heat input (both solar and fossil) into the integrated cycle as compared to the separate heat inputs required to two standalone cycles.

Additionally, the integrated power generation systems disclosed herein can provide a utility with the ability to qualify for tax and other economic incentives based upon facilities producing a high percentage of renewable energy. Additionally, the integrated power generation systems disclosed herein are simple and inexpensive to build, operate and maintain. These integrated power generation systems can be used in both new construction and in retrofit applications. In most retrofit applications, retrofitting is a simple process since no internal modifications are needed to the heat recovery device or turbine combined cycle power generation system.

Additionally, the methods disclosed herein of superheating a working fluid in a solar Rankine cycle provide a power generation operator with flexibility, both in initial design and in subsequent operation. The power generation operator can mix and match several different gas combustion electrical generators with a solar field to meet different operating criteria and different solar fractions. Unlike the ISCCS, the systems and methods disclosed herein are not bound by a single integrated power generation system design. The solar field and the gas combustion electrical generator can be efficiently operated without the other when necessary.

For example, the integrated power generation systems can include valves to isolate the combined cycle power generation system from the solar Rankine power generation system at night or during highly cloudy periods. This separation of power generation systems is virtually impossible in an ISCCS, where both the solar field and the gas turbine electric generator are adapted to work together. Moreover, the power generation system operator can design the integrated power generation systems disclosed herein over a wide range of temperatures and pressures to meet different operating criteria and solar fractions, without markedly effecting overall efficiency.

Although certain embodiments and examples have been described herein, it will be understood by those skilled in the art that many aspects of the systems and methods shown and described in the present disclosure may be differently combined and/or modified to form still further embodiments. Additionally, it will be recognized that the methods described herein may be practiced using any systems or devices suitable for performing the recited steps. Such alternative embodiments and/or uses of the methods, systems, and devices described above and obvious modifications and equivalents thereof are intended to be within the scope of the present disclosure. Thus, it is intended that the scope of the present invention should not be limited by the particular embodiments described above, but should be determined only by a fair reading of the claims that follow.

What is claimed is:

1. A method for generating power, the method comprising the steps of:
generating a heated reheat of a first working fluid in a first power generation system;
vaporizing a second working fluid liquid in a second power generation system to form a second working fluid vapor;
transferring energy from the reheat of the first working fluid to the second working fluid vapor thus increasing a temperature and a pressure of the second working fluid vapor of the second power generation system.

2. The method of claim 1, wherein the first power generation system comprises a combined cycle power generation system and wherein the step of generating reheat of a first working fluid comprises the steps of:
producing a heated exhaust gas in a combustion turbine;
transferring heat energy from the heated exhaust gas of the combustion turbine to the first working fluid liquid in a heat recovery device to generate a first working fluid vapor;
expanding the first working fluid vapor of the first power generation system in an expansion turbine to form a cold reheat of the first working fluid vapor;
transferring heat energy from the heated exhaust gas of the combustion turbine to the cold reheat in the heat recovery device to form a heated reheat.

3. The method of claim 1, wherein the step of vaporizing a second working fluid liquid comprises the steps of:
heating a solar energy transfer fluid with solar energy collected in a solar collector array; and
heating the second working fluid liquid in a vaporizer with the solar energy transfer fluid to vaporize the second working fluid liquid.

4. The method of claim 1, wherein the step of transferring energy from the heated reheat to the second working fluid vapor comprises the steps of:
transferring the second working fluid vapor to a superheater; and
transferring the heated reheat to the superheater.

5. The method of claim 1, further comprising the step of driving a turbine electric generator with the second working fluid vapor after it has received energy from the heated reheat.

6. The method of claim 5, further comprising the step of driving the turbine electric generator with the heated reheat after it has transferred energy to the second working fluid vapor.

7. The method of claim 6, wherein the step of driving the turbine electric generator with the heated reheat comprises the step of combining the first working fluid and the second working fluid in the turbine electric generator.

8. The method of claim 7, further comprising the steps of
condensing the first working fluid and the second working fluid after the step of driving the turbine electric generator to form a working fluid condensate; and
returning a portion of the working fluid condensate to the first working fluid in the first power generation system.

9. A method to increase the thermodynamic availability of a first working fluid vapor having a first temperature and a first pressure, the method comprising the steps of:
transferring the first working fluid vapor to a superheater;
transferring a second working fluid vapor to the superheater, the second working fluid vapor having a second temperature that is lower than the first temperature and a second pressure that is higher than the first pressure;
transferring heat energy in the superheater from the first working fluid vapor to the second working fluid vapor to increase the temperature and pressure of the second working fluid vapor.

10. The method of claim 9, further comprising the step of driving a turbine electric generator with the second working fluid vapor after it has received energy from the first working fluid vapor in the superheater.

11. The method of claim 10 further comprising the step of driving the turbine electric generator with the first working fluid vapor after it has transferred energy to the second working fluid vapor in the superheater.

12. A power generation system comprising:
a solar energy collector;
a solar boiler connected to the solar collector with a working fluid conduit configured to circulate a first working fluid to transfer heat from the solar energy collector to the solar boiler;
a first expansion turbine;
a steam circuit extending from the solar boiler to the first expansion turbine; and
a heat transfer device connected to the steam circuit between the solar boiler and the first expansion turbine, the heat transfer device being configured to transfer heat from reheated steam in a combined cycle power generation system to steam in the steam circuit.

13. The system according to claim 12, wherein the first expansion turbine is connected to a heat recovery system generator of the combined cycle system.

14. The system according to claim 12, wherein the combined cycle system includes a second expansion turbine that is not connected to the steam circuit.
